(19) United States
(12) Patent Application Publication
(10) Pub. No.: US 2022/0205801 A1
(43) Pub. Date: Jun. 30, 2022

(54) WALK THROUGH DISPLAY DEVICE, WALK THROUGH DISPLAY METHOD, AND WALK THROUGH DISPLAY PROGRAM

(71) Applicant: NIPPON TELEGRAPH AND TELEPHONE CORPORATION, Tokyo (JP)

(72) Inventors: Mitsuru MOCHIZUKI, Tokyo (JP); Kyota TSUTSUMIDA, Tokyo (JP); Osamu MATSUDA, Tokyo (JP); Hitoshi SESHIMO, Tokyo (JP)

(73) Assignee: NIPPON TELEGRAPH AND TELEPHONE CORPORATION, Tokyo (JP)

(21) Appl. No.: 17/610,648

(22) PCT Filed: May 13, 2019
(86) PCT No.: PCT/JP2019/018989

§ 371 Date: Nov. 11, 2021

(51) Int. Cl. G01C 21/36; G01C 21/34

(52) U.S. Cl. CPC G01C 21/3617; G01C 21/3638; G01C 21/3476

(57) ABSTRACT

It is possible to display the state of the current route even with a large change in visual field in an easy-to-understand manner. A grouping unit (102) groups a plurality of nodes included in a route on a map into groups having no change in line-of-sight in an order of travel direction on the route. A point generation unit (103) generates, for each of the groups grouped by the route grouping unit, a plurality of points included in a route of the group so that the route is divided into smaller sections by the points from a start point of the group toward an end point of the group. A viewpoint determination unit (104) determines, for each of the plurality of points, a viewpoint in accordance with a condition of the point. A walk-through display unit (105) performs walk-through display for displaying a scenery corresponding to the determined viewpoint.

### TECHNICAL FIELD

The technique disclosed herein relates to a walk-through display device, a walk-through display method, and a walk-through display program.

### BACKGROUND ART

For navigating a person, walk-through display has been performed in which a three-dimensional map or video is used to move a position in a virtual space where the same scenery as in actual traveling can be displayed for navigation. When a predetermined route or a route obtained by performing a route search is used for navigation, the method of PTL 1 provides walk-through display in which a position moves on a route at the same time and at the same interval without giving the user a degree of freedom while changing the height and direction (viewpoint to a route ahead of the current point) where the user is to view.

### CITATION LIST

### Patent Literature

[PTL 1] Japanese Patent Application Publication No. 2019-016099

### SUMMARY OF THE INVENTION

### Technical Problem

However, in the method of PTL 1, for navigating on a route as illustrated on the upper side in FIG. 1, the route is divided by points arranged at equal intervals as illustrated on the lower side in FIG. 1, so that traveling can be provided between the points at the same time interval. Thus, there is a problem that even for a visual field being open such as between A and C and between F and H (elliptical portions with dashed lines in FIG. 1), it takes a long time to travel on such a route with a few changes, and conversely, for a visual field not being open such as around C or between D and F (elliptical portion with a solid line in FIG. 1), it takes a short time to travel on such a route with many changes. For a visual field being open, pedestrians are less likely to get lost, so that their walking speed increases, and conversely, for just before a corner not being open, they are more likely to get lost, so that their walking speed decreases to understand the current situation.

Further, in the method of PTL 1, there is a problem that as illustrated in FIG. 2, the direction ahead of the viewpoint at a certain point is directed to a point located ahead on the route when traveling on the route, so that the scenery at a corner is switched to that outside the visual field, which makes it difficult to understand the current situation.

The technique disclosed herein has been made in view of the foregoing, and an object of the present invention is to provide a walk-through display device, a walk-through display method, and a walk-through display program that can easily display the state of the current route even for a large change in the visual field.

### Means for Solving the Problem

A first aspect of the present disclosure is a walk-through display device including: a node acquisition unit that acquires a plurality of nodes included in a route on a chart; a route grouping unit that groups the plurality of nodes into groups having no change in line-of-sight in an order of travel direction on the route; a point generation unit that generates, for each of the groups grouped by the route grouping unit, a plurality of points included in a route of the group so that the route is divided into smaller sections by the points from a start point of the group toward an end point of the group; a viewpoint determination unit that determines, for each of the plurality of points generated by the point generation unit, a viewpoint in accordance with a condition of the point; and a walk-through display unit that performs walk-through display for displaying a scenery during traveling on the route, the walk-through display displaying, at each of the plurality of points, a scenery corresponding to the viewpoint determined by the viewpoint determination unit.

A second aspect of the present disclosure is the walk-through display device, wherein the route grouping unit may include determining that there is a change in line-of-sight at a node of interest of the plurality of nodes when an angle by which a viewpoint turns to a direction of viewpoint from the node of interest to a node next to the node of interest with respect to a direction of viewpoint from a node immediately preceding the node of interest to the node of interest is larger than a predetermined first threshold value, and generating a group having the node of interest serving as an end point and a group having the node of interest serving as a start point.

A third aspect of the present disclosure is the walk-through display device, wherein the viewpoint determination unit may include, for each of the groups grouped by the route grouping unit, setting, for each point of the group other than the point corresponding to the end point of the group, a point next to each point as a viewpoint, and determining, for the point corresponding to the end point of the group, a viewpoint according to an angle by which the viewpoint turns to a direction of viewpoint from a point corresponding to an end point to a point next to the point corresponding to the end point with respect to a direction of viewpoint from a point immediately preceding the point corresponding to the end point to the point corresponding to the end point.

A fourth aspect of the present disclosure is a walk-through display method including: acquiring, by a node acquisition unit, a plurality of nodes included in a route on a map; grouping, by a route grouping unit, the plurality of nodes into groups having no change in line-of-sight in an order of travel direction on the route; generating, by a point generation unit, for each of the groups grouped by the route grouping unit, a plurality of points included in a route of the group so that the route is divided into smaller sections by the points from a start point of the group toward an end point of the group; determining, by a viewpoint determination unit, for each of the plurality of points generated by the point generation unit, a viewpoint in accordance with a condition of the point; and performing, by a walk-through display unit, walk-through display for displaying a scenery during traveling on the route, the walk-through display displaying, at each of the plurality of points, a scenery corresponding to the viewpoint determined by the viewpoint determination unit.

A fifth aspect of the present disclosure is a walk-through display program causing a computer to execute: acquiring, by a node acquisition unit, a plurality of nodes included in a route on a map; grouping, by a route grouping unit, the plurality of nodes into groups having no change in line-of-sight in an order of travel direction on the route; generating, by a point generation unit, for each of the groups grouped by the route grouping unit, a plurality of points included in a route of the group so that the route is divided into smaller sections by the points from a start point of the group toward an end point of the group; determining, by a viewpoint determination unit, for each of the plurality of points generated by the point generation unit, a viewpoint in accordance with a condition of the point; and performing, by a walk-through display unit, walk-through display for displaying a scenery during traveling on the route, the walk-through display displaying, at each of the plurality of points, a scenery corresponding to the viewpoint determined by the viewpoint determination unit.

### Effects of the Invention

According to the disclosed technique, it is possible to display the state of the current route even with a large change in visual field in an easy-to-understand manner.

### BRIEF DESCRIPTION OF DRAWINGS

FIG. 1 is a diagram illustrating an example of a route with many changes and a route with a few changes in conventional walk-through display.

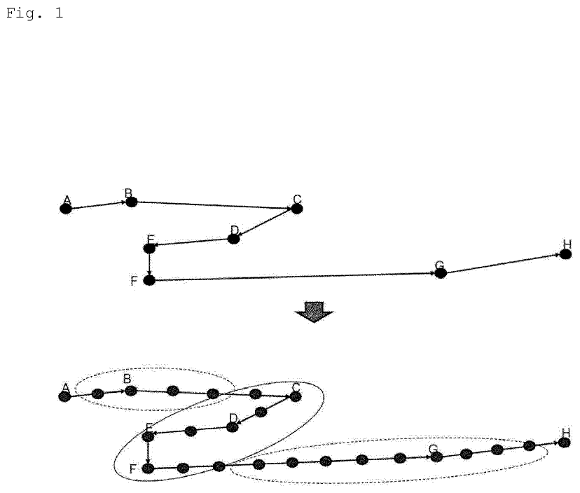

FIG. 2 is a diagram illustrating an example of viewpoints at corners in the conventional walk-through display.

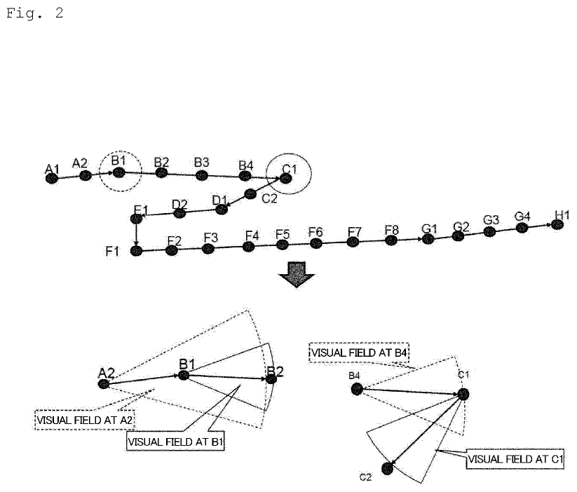

FIG. 3 is a block diagram illustrating a schematic configuration of a computer that functions as a walk-through display device according to the present embodiment.

FIG. 4 is a block diagram illustrating an example of a functional configuration of the walk-through display device according to the present embodiment.

FIG. 5 is a diagram illustrating an example of a route.

FIG. 6 is a diagram illustrating an example of a line-of-sight of a node.

FIG. 7 is a diagram illustrating an example of grouping for a route.

FIG. 8 is a diagram illustrating an example of point generation.

FIG. 9 illustrates an example of a determination rule for a viewpoint.

FIG. 10 is a diagram illustrating an example of viewpoint determination for points other than an end point of each group.

FIG. 11 is a diagram illustrating an example of viewpoint determination for a point as an end point of each group.

FIG. 12 illustrates an example of a difference in a visual field at a corner between the walk-through display device according to the present embodiment and a conventional technique.

FIG. 13 is a flowchart illustrating a walk-through display processing routine of the walk-through display device according to the present embodiment.

FIG. 14 is a flowchart illustrating a point generation processing routine of the walk-through display device according to the present embodiment.

FIG. 15 is a flowchart illustrating a viewpoint determination processing routine of the walk-through display device according to the present embodiment.

### DESCRIPTION OF EMBODIMENTS

<Configuration of Walk-Through Display Device According to Embodiment of Technique of Present Disclosure>

Hereinafter, example embodiments of a technique disclosed herein will be described with reference to the drawings. Note that the same reference numerals are given to the same or equivalent components and parts among the drawings. Further, the dimensional ratios in the drawings are exaggerated for convenience of explanation and may differ from the actual ratios.

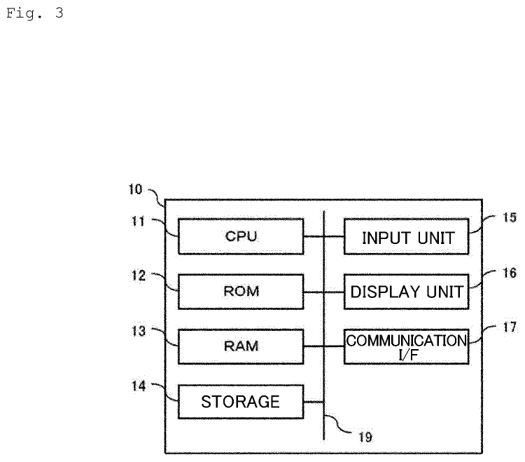

FIG. 3 is a block diagram illustrating a hardware configuration of a walk-through display device 10 according to the present embodiment.

As illustrated in FIG. 3, the walk-through display device 10 includes a CPU (Central Processing Unit) 11, a ROM (Read Only Memory) 12, a RAM (Random Access Memory) 13, a storage 14, an input unit 15, a display unit 16, and a communication interface (I/F) 17. The respective components are communicably connected to each other via a bus 19.

The CPU 11 is a central arithmetic processing unit that executes various types of programs and controls the respective units. Specifically, the CPU 11 reads a program from the ROM 12 or the storage 14 to execute the program using the RAM 13 as a work area. The CPU 11 controls each of the above components and performs various types of arithmetic processing in accordance with the program stored in the ROM 12 or the storage 14. In the present embodiment, the ROM 12 or the storage 14 stores a walk-through display program for executing walk-through display processing.

The ROM 12 stores various types of programs and various types of data. The RAM 13 temporarily stores a program or data as a work area. The storage 14 is composed of an HDD (Hard Disk Drive) or an SSD (Solid State Drive), and stores various types of programs including an operating system, and various types of data.

The input unit 15 includes a pointing device such as a mouse and a keyboard, and is used for performing various types of inputs.

The display unit 16 is, for example, a liquid crystal display and displays various types of information. The display unit 16 may adopt a touch panel method and function as the input unit 15.

The communication interface 17 is an interface for communicating with other devices, and uses, for example, standards such as Ethernet (registered trademark), FDDI, and Wi-Fi (registered trademark).

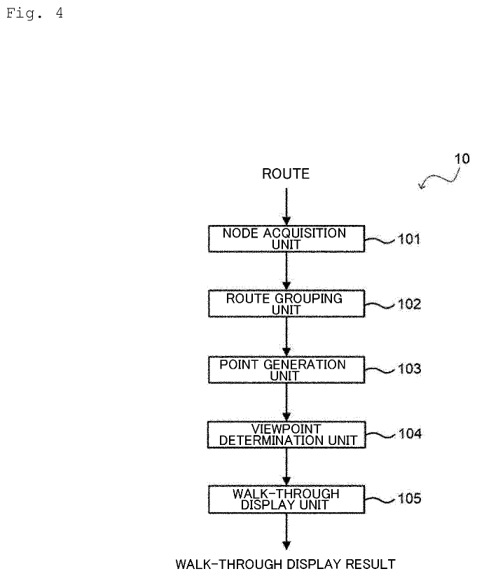

Next, a functional configuration of the walk-through display device 10 will be described. FIG. 4 is a block diagram illustrating an example of the functional configuration of the walk-through display device 10.

As illustrated in FIG. 4, the walk-through display device 10 includes a node acquisition unit 101, a route grouping unit 102, a point generation unit 103, a viewpoint determination unit 104, and a walk-through display unit 105, which are functional components. Each functional component is implemented by the CPU 11 reading the walk-through display program stored in the ROM 12 or the storage 14, loading the program into the RAM 13, and executing the program.

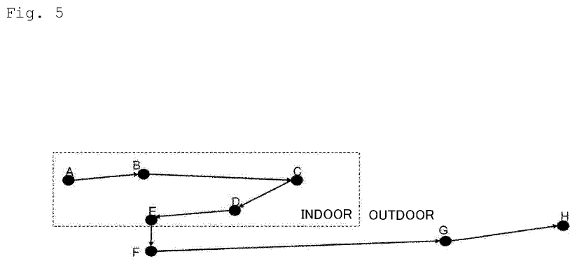

The node acquisition unit 101 acquires a plurality of nodes included in a route on a map. In the present embodiment, a case will be described as an example where the node acquisition unit 101 acquires a plurality of nodes included in a route as illustrated in FIG. 5. Specifically, the node acquisition unit 101 acquires eight nodes having node IDs A to H illustrated in FIG. 5 as nodes for the route. Hereinafter, a node whose node ID is i (i is any symbol) is referred to as “node i”. The route illustrated in FIG. 5 is a route having node A which serves as a start point, passing through nodes B, C, D, E, F, and G in order, and having node H which serves as an end point. Further, the route illustrated in FIG. 5 corresponds to, for example, a route in which nodes A to E are indoors and nodes F to H are outdoors. Then, the node acquisition unit 101 passes the acquired nodes to the route grouping unit 102.

The route grouping unit 102 groups a plurality of nodes into groups having no change in line-of-sight in an order of travel direction on the route. Specifically, the route grouping unit 102 performs the grouping by dividing the route into before and after a target node in a manner that determines that there is a change in line-of-sight at the target node of the plurality of nodes when an angle formed by the target node, a node immediately preceding the target node, and a node next to the target node is larger than a predetermined first threshold value, and generates a group having the target node serving as an end point and a group having the target node serving as a start point.

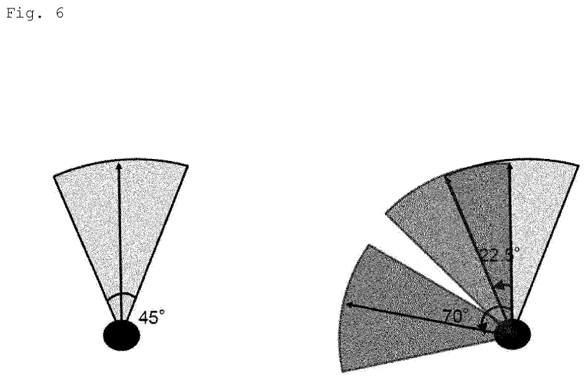

The line-of-sight of a node will now be described. As illustrated in FIG. 6, in a case where the human visual field is in a range of 45° with the center line in the direction of a viewpoint (left in FIG. 6), the viewpoint turning 22.5°, which is half of that angle range, causes a visual field in the direction of a new viewpoint at a certain node in which there is a 22.5°-ranging visual field that overlaps with the visual field in the direction of the viewpoint at a node immediately preceding the certain node (for a 22.5° turning on the right in FIG. 6). Accordingly, the viewpoint turning at the certain node results in continuous visual fields and visual fields with small changes. Therefore, it can be said that the node having a viewpoint turning of less than 22.5° is not a corner and has a good line-of-sight. On the other hand, for a viewpoint turning of more than 22.5°, the overlapping visual field gradually decreases, and when it exceeds 45°, the overlapping region disappears, which results in a discontinuous visual field and a visual field with a large change. For example, for a viewpoint turning of 70°, there is no region overlapping the visual field in the direction of the viewpoint at the node immediately preceding the certain node (for a 70° turning on the right in FIG. 6). Therefore, it can be said that the node having a viewpoint turning of more than 22.5° is a corner or the like and has a poor line-of-sight.

Therefore, when the route grouping unit 102 pays attention to a certain node, a group of nodes with continuous visual fields is generated in which a start point is the node of interest and an end point is a node at the timing when a viewpoint turning of more than 22.5° is required (the timing resulting in a discontinuous visual field). The angle of viewpoint turning at the node of interest can be calculated, for the node of interest for example, by calculating an angle by which the viewpoint turns to the direction of viewpoint from the node of interest to the node next to the node of interest with respect to the direction of viewpoint from the node immediately before the node of interest to the node of interest.

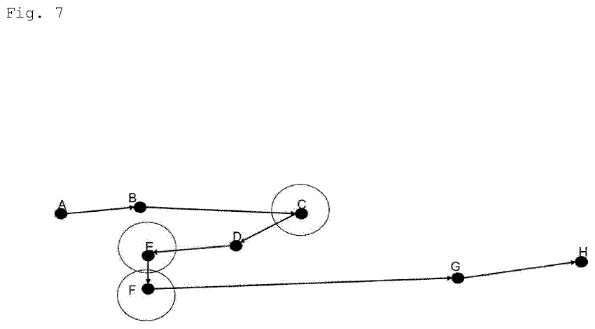

FIG. 7 illustrates an example of route grouping for a threshold value of 22.5°. As illustrated in FIG. 7, circled nodes C, E, and F are nodes that each require a viewpoint turning of 22.5°. Therefore, the route grouping unit 102 divides the route into four groups [A, B, C], [C, D, E], [E, F], and [F, G, H]. Then, the route grouping unit 102 passes the grouped plurality of nodes to the point generation unit 103.

The point generation unit 103 generates, for each of the groups grouped by the route grouping unit 102, a plurality of points included in a route of the group so that the route is divided into smaller sections by the points from a start point of the group toward an endpoint of the group. Specifically, the point generation unit 103 generates, for each of the groups grouped by the route grouping unit 102, points corresponding to the start point and end point of the group on the route of the group at the positions of the nodes of the start point and end point. Further, the point generation unit 103 generates points at positions between the start point of the group and the end point of the group, and positions where the route is divided into smaller sections by the points from a start point of the group toward an endpoint of the group. Here, the travel durations between the points generated by the point generation unit 103 are generated to be equal. Specifically, the point generation unit 103 generates points by which travel intervals are smaller from the start point toward the endpoint on the route of the group, so that a distance of traveling for the same period of time is longer at a stage of good line-of-sight and is shorter at a stage of poor line-of-sight. Note that the point generation unit 103 generates a point at the start point of the group only for the first group, and sets, for the second and subsequent groups, a point corresponding to the end point of the immediately preceding group as a point corresponding to the start point of the group.

Here, the point generation unit 103 sets a point number for each point for the purpose of making the points unique. For the point number, 1 is added to the end of the node ID of the node at the same position for the start point of each group, and 0 is added to the end of the node ID of the node at the same position for the end point of each group. Next, the point generation unit 103 determines whether or not the distance of the route from the start point to the endpoint is equal to or less than a predetermined second threshold value, and if the distance is equal to or less than the second threshold value, the point generation unit 103 ends the generation of points for that group. On the other hand, if the distance exceeds the second threshold value, the point generation unit 103 generates a new point at the midpoint of the distance of the route between the start point and the end point, and determines whether or not the distance of the route between the generated new point and the endpoint is equal to or less than the second threshold value. If the distance of the route between the new point and the end point is equal to or less than the second threshold value, the generation of points for the group is ended, and if the distance of the route between the new point and the end point exceeds the second threshold value, a new point is generated again at the midpoint of the distance of the route between the new point and the end point, and the same processing is repeated. The point generation unit 103 performs the above-described point generation processing for all groups. Note that for each of the points between the start point and the end point of each group, a unique serial number is added to the node ID immediately before the position of the points. Hereinafter, the point of point number j (j is any symbol) is referred to as “point j” or simply “j”.

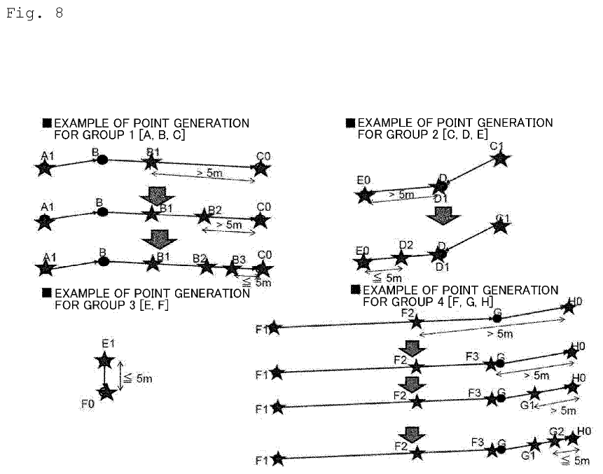

FIG. 8 illustrates examples of the result of generating points by the point generation unit 103 for each of group 1 [A, B, C], group 2 [C, D, E], group 3 [E, F], and group 4 [F, G, H] grouped by the route grouping unit 102. In each example, a case will be described as an example where the second threshold value is 5 m. For example, for group 1, point A1 is generated at the position of node A which is a start point, and C0 is generated at the position of node C which is an end point. At this time, since the distance of the route between A1 and C0 exceeds 5 m, point B1 is generated at the midpoint of the distance of the route between A1 and C0. Furthermore, since the distance of the route between B1 and C0 exceeds 5 m, point B2 is generated at the midpoint of the distance of the route between B1 and C0. Furthermore, since the distance of the route between B2 and C0 exceeds 5 m, point B3 is generated at the midpoint of the distance of the route between B2 and C0. Since the distance of the route between B3 and C0 is within 5 m, the processing of generating points for group 1 ends, and that processing is repeated for the next group. After that, the processing is repeated until the processing for each group ends. By repeating the generation of points in this way, a distance of traveling for the same period of time can be made longer at a stage of good line-of-sight and shorter at a stage of poor line-of-sight. Note that this point generation can solve not only for the plane but also for the height (Z-axis) in the same manner. Then, the point generation unit 103 passes the plurality of points included in the route for each of the generated groups to the viewpoint determination unit 104.

The viewpoint determination unit 104 determines a viewpoint for each of the plurality of points generated by the point generation unit 103 in accordance with a condition for the point. Specifically, for each of the groups grouped by the route grouping unit 102 by the route grouping unit, the viewpoint determination unit 104 sets, for each point of the group other than the point corresponding to the end point of the group, a point next to each point as a viewpoint. For the point corresponding to the endpoint of the group, it is determined a viewpoint according to an angle by which the viewpoint turns to a direction of viewpoint from a point corresponding to an end point to a point next to the point corresponding to the end point with respect to a direction of viewpoint from a point immediately preceding the point corresponding to the end point to the point corresponding to the endpoint. In the present embodiment, the satisfaction of the above condition is determined based on whether or not the end of the point number is 0. The method of determination is not limited to this, and may be determination according to the relationship between the positions of the node and the point.

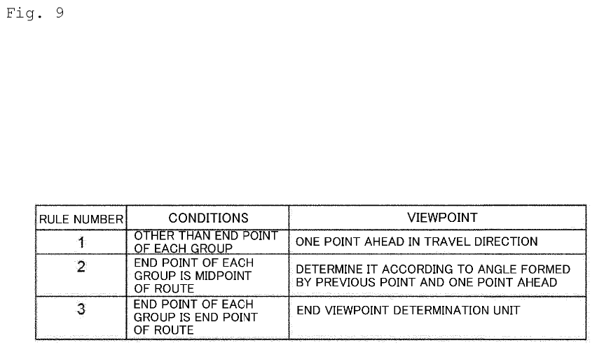

FIG. 9 illustrates an example of a determination rule for a viewpoint according to a point condition. In this case, the viewpoint determination unit 104 sets, for each point other than the endpoint of each group, one point ahead in the travel direction as a viewpoint because it has a small change in visual field. When the end point of each group is the middle point of the route, it has a large change in visual field, and thus the viewpoint determination unit 104 determines a viewpoint according to an angle formed by a point of end point of the group, a point immediately before that point, and one point ahead of that point. When the end point of each group is the end point of the route, the viewpoint determination unit 104 ends the viewpoint determination processing.

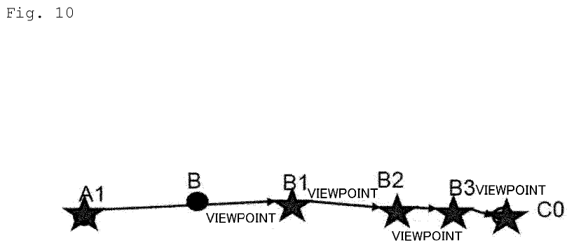

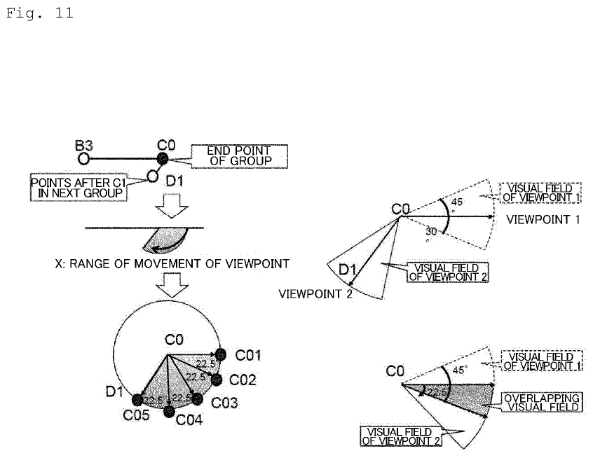

FIG. 10 illustrates an example of determining viewpoints at points other than the end point of each group. In this example, the viewpoint at point A1 is B1, and the viewpoint at point B1 is B2. Further, FIG. 11 illustrates an example of determining a viewpoint at the end point of each group. In this example, a viewpoint is determined according to an angle formed by a point of end point of the group, one previous point, and a point ahead of a point of start point of one group ahead. For example, when a pedestrian travels from B3 to C0 and then from C1 (=C0) to D1, the viewpoint moves in the arrow direction in a fan-shaped range. At that time, it is assumed that the range of the visual field that a person can recognize is 45°. On the other hand, if the viewpoint at C1 is directed to D1, which is one point ahead in the walk-through display, the entire visual field is switched to a region that was previously out of the visual field, which makes it difficult for the user to understand the current state of traveling.

Therefore, the viewpoint determination unit 104 generates a circle centered on C0 and having a radius which is a distance between C0 and D1, divides the range in which the viewpoint moves by every 22.5°, and generates the resulting points on the generated circle as viewpoints. At that time, if the angle of the range in which the viewpoint moves is less than 22.5°, D1 which is one point ahead may be used as a viewpoint without dividing. The angle by which the visual field is divided is not limited to this, and may be changed according to the actual view. Note that for a point located at the endpoint of the route (here, point number H0), the viewpoint determination unit 104 does not determine a viewpoint because there is no traveling beyond that point.

In this way, by generating a new viewpoint and sequentially changing the viewpoint, the visual field in the walk-through display can have an overlapping region before and after the turning of the viewpoint. For example, if the recognizable visual field range is 45° and the viewpoint movement angle is 22.5°, the 22.5° ranges overlap. Note that this viewpoint determination can solve not only for the plane but also for the movement of the height (Z axis) in the same manner. For example, for stairs, escalators, and the like, which are used for movement in height (Z axis), overlapping regions can be provided before and after turning of the viewpoint according to the movement angle of the viewpoint in the same manner. However, as an exception, when the travel direction is almost vertical like an elevator, directing the viewpoint in the travel direction results in directing the viewpoint just above or directly below, so that the viewpoint direction may be better not to move. In that case, the viewpoint may simply be moved only in height without moving the direction of the viewpoint in the travel direction. A viewpoint number is set for the purpose of making the viewpoint unique. The viewpoint number is a number in which a serial number is added to the point number at the center of the circle. The serial number is incremented from the viewpoint far from the position of D1. Hereinafter, the viewpoint of viewpoint number k (k is any symbol) is referred to as “viewpoint k”. Switching the viewpoints in the order of viewpoints C01, C02, C03, C04, and C05 thus generated makes it possible to solve the problem that the user cannot understand the current state at a corner in the walk-through display. Then, the viewpoint determination unit 104 passes the viewpoint determined at each of the plurality of points to the walk-through display unit 105.

The walk-through display unit 105 performs walk-through display for displaying a scenery during traveling on a route and displaying, at each of the plurality of points, a scenery corresponding to the viewpoint determined by the viewpoint determination unit 104. Specifically, the walk-through display unit 105 performs walk-through display based on the point where the viewpoint is determined. By performing the walk-through display based on the determined viewpoint, a distance of traveling for the same period of time can be made longer at a stage of good line-of-sight and shorter at a stage of poor line-of-sight. Further, by having a continuous visual field for even a corner with a large change in visual field, the current state can be displayed in an easy-to-understand manner for the user.

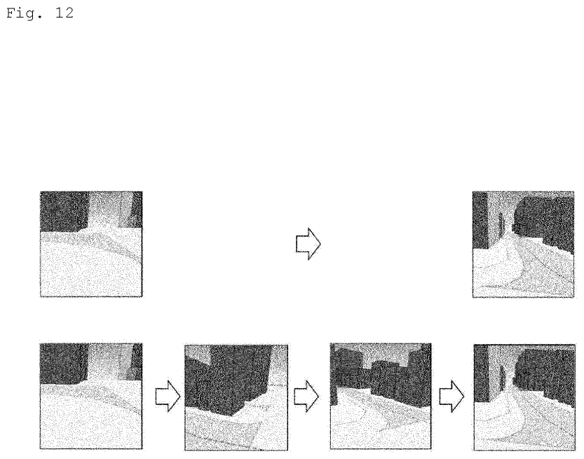

FIG. 12 illustrates an example of a difference in view between a case where the viewpoint at a corner is switched to one point ahead in the walk-through display and a case where the viewpoint is sequentially switched within the range of the visual field by the walk-through display device 10. On the upper side in FIG. 12, an example is illustrated in which the viewpoint at a corner is switched to one point ahead. As illustrated, in the conventional method, since the visual field changes suddenly at a corner or the like, the display makes it difficult to understand the current state. On the other hand, as illustrated on the lower side in FIG. 12, the display provided by the walk-through display device 10 makes it possible to have a continuous visual field, so that the current state can be easily understood.

<Operation of Walk-Through Display Device According to Embodiment of Technique of Present Disclosure>

Next, an operation of the walk-through display device 10 will be described.

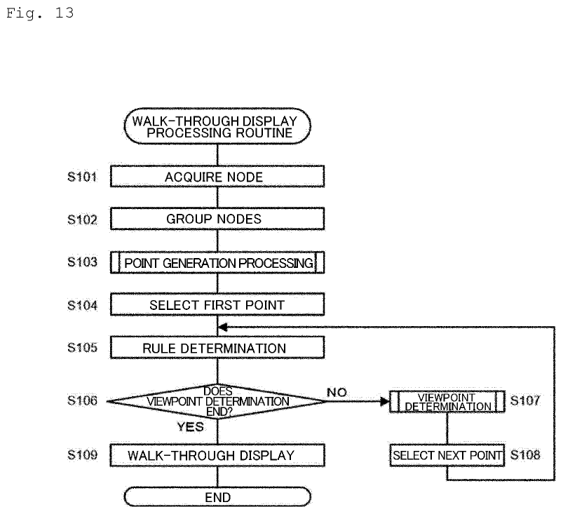

FIG. 13 is a flowchart illustrating a flow of a walk-through display processing routine performed by the walk-through display device 10. The walk-through display processing routine is performed by the CPU 11 reading the walk-through display program from the ROM 12 or the storage 14, loading the program into the RAM 13, and executing the program.

In step S101, the CPU 11 serves as the node acquisition unit 101 to acquire a plurality of nodes included in a route on a map.

In step S102, the CPU 11 serves as the route grouping unit 102 to group the plurality of nodes into groups having no change in line-of-sight in an order of travel direction on the route.

In step S103, the CPU 11 serves as the point generation unit 103 to perform point generation processing of generating, for each of the groups grouped in step S102, a plurality of points included in a route of the group so that the route is divided into smaller sections by the points from a start point of the group toward an end point of the group.

In step S104, the CPU 11 serves as the viewpoint determination unit 104 to select the first point.

In step S105, the CPU 11 serves as the viewpoint determination unit 104 to perform rule determination on the selected point in accordance with, for example, viewpoint determination rules illustrated in FIG. 9.

In step S106, the CPU 11 serves as the viewpoint determination unit 104 to determine whether or not the determination result in step S105 indicates the end of the viewpoint determination.

If it does not indicate the end of the viewpoint determination (NO in step S106), in step S107, the CPU 11 serves as the viewpoint determination unit 104 to perform viewpoint determination processing of determining a viewpoint at the selected point according to the determination result of step S105.

In step S108, the CPU 11 serves as the viewpoint determination unit 104 to select the next point and return to step S105.

On the other hand, if it indicates the end of the viewpoint determination (YES in step S106), in step S109, the CPU 11 serves as the walk-through display unit 105 to performs walk-through display for displaying a scenery during traveling on a route and displaying, at each of the plurality of points, a scenery corresponding to the viewpoint determined in step S107.

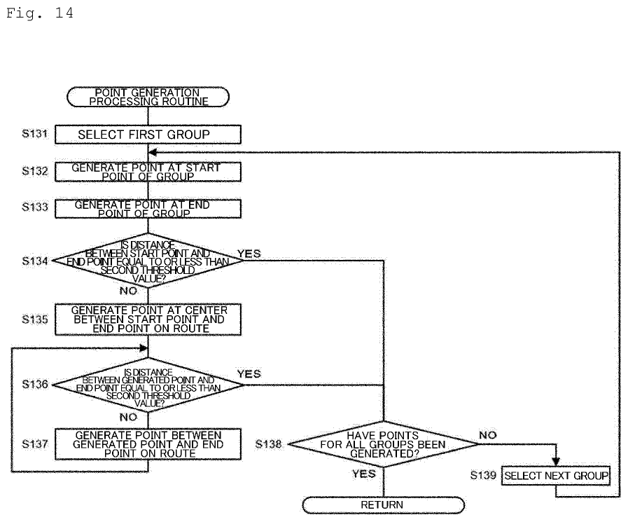

The point generation processing in step S103 will now be described in detail. FIG. 14 is a flowchart illustrating a flow of the point generation processing routine performed by the walk-through display device 10.

In step S131, the CPU 11 serves as the point generation unit 103 to select the first group.

In step S132, the CPU 11 serves as the point generation unit 103 to generate a point at the start point of the selected group.

In step S133, the CPU 11 serves as the point generation unit 103 to generate a point at the endpoint of the selected group.

In step S134, the CPU 11 serves as the point generation unit 103 to determine whether or not the distance of the route between the start point generated in step S132 and the end point generated in step S133 is equal to or less than a predetermined second threshold value.

If the distance of the route between the start point generated in step S132 and the end point generated in step S133 is not equal to or less than the second threshold value (NO in step S134), in step S135, the CPU 11 serves as the point generation unit 103 to generate a new point at the midpoint of the distance of the route between the start point generated in step S132 and the end point generated in step S133.

In step S136, the CPU 11 serves as the point generation unit 103 to determine whether or not the distance of the route between the new point generated in step S135 and the end point generated in step S133 is equal to or less than the second threshold value.

If the distance of the route between the new point generated in step S135 and the end point generated in step S133 is not equal to or less than the second threshold value (NO in step S136), in step S137, the CPU 11 serves as the point generation unit 103 to generate a new point again at the midpoint of the distance of the route between the new point generated in step S135 and the end point generated in step S133. Then, the processing returns to step S136 to determine whether or not the distance of the route between the new point generated in step S136 and the end point generated in step S133 is equal to or less than the second threshold value.

On the other hand, if the distance of the route between the start point generated in step S132 and the path of the endpoint generated in step S133 is equal to or less than the second threshold value (YES in step S134), or if the distance of the route between the new point and the end point generated in step S133 is equal to or less than the second threshold value (YES in step S136), in step S138, the CPU 11 serves as the point generation unit 103 to determine whether or not points for all groups have been generated.

If points for all groups have not been generated (NO in step S138), in step S139, the CPU 11 serves as the point generation unit 103 to select the next group and returns to step S132 to perform processing of steps S132 to S138 again.

On the other hand, if points for all groups have been generated (YES in step S138), the CPU 11 returns.

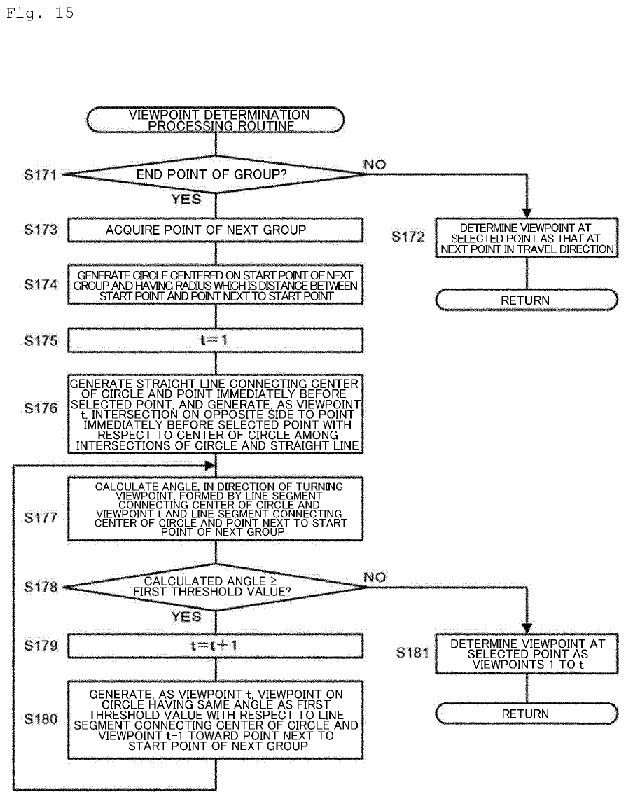

The viewpoint determination processing in step S107 will now be described in detail. FIG. 15 is a flowchart illustrating a flow of the viewpoint determination processing routine performed by the walk-through display device 10.

In step S171, the CPU 11 serves as the viewpoint determination unit 104 to determine whether or not the point currently selected in step S104 or step S108 (hereinafter referred to as the selected point) is the end point of the group to which the selected point belongs.

If the selected point is not the end point (NO in step S171), in step S172, the CPU 11 serves as the viewpoint determination unit 104 to determine a viewpoint at the selected point as that at the next point in the travel direction and return.

On the other hand, if the selected point is the endpoint (YES in step S171), in step S173, the CPU 11 serves as the viewpoint determination unit 104 to acquire a point of the group next to the group to which the selected point belongs.

In step S174, the CPU 11 serves as the viewpoint determination unit 104 to generate a circle centered on the start point of the next group acquired in step S173 and having a radius which is a distance between the start point and a point next to the start point.

In step S175, the CPU 11 serves as the viewpoint determination unit 104 to set t=1. Here, t is a count value for counting the viewpoint number of the viewpoint at the selected point.

In step S176, the CPU 11 serves as the viewpoint determination unit 104 to generate a straight line connecting the center of the circle generated in step S174 and a point immediately before the selected point, and generate, as viewpoint t, an intersection on the opposite side to a point immediately before the selected point with respect to the center of the circle among the intersections of the circle and the straight line.

In step S177, the CPU 11 serves as the viewpoint determination unit 104 to calculate an angle, in the direction of turning the viewpoint, formed by a line segment connecting the center of the circle and viewpoint t and a line segment connecting the center of the circle and a point next to the start point of the next group.

In step S178, the CPU 11 serves as the viewpoint determination unit 104 to determine whether or not the angle calculated in step S177 is equal to or greater than a predetermined first threshold value.

If the calculated angle is equal to or greater than the predetermined first threshold value (YES in step S178), in step S179, the CPU 11 serves as the viewpoint determination unit 104 to add 1 to t.

In step S180, the CPU 11 serves as the viewpoint determination unit 104 to generate, as viewpoint t, a viewpoint on the circle having the same angle as the first threshold value with respect to a line segment connecting the center of the circle and viewpoint t−1 toward a point next to the start point of the next group, and return to step S177.

On the other hand, if the calculated angle is not equal to or greater than the predetermined first threshold value (NO in step S178), in step S181, the CPU 11 serves as the viewpoint determination unit 104 to determine a viewpoint at the selected point as one of viewpoints 1 to t and return. At the selected point, the viewpoints 1 to t are sequentially displayed as walk-through.

As described above, the walk-through display device according to the present embodiment groups a plurality of nodes included in a route on a map into groups having no change in line-of-sight in an order of travel direction on the route, and generates, for each of the groups grouped, a plurality of points included in a route of the group so that the route is divided into smaller sections by the points from a start point of the group toward an endpoint of the group. Then, walk-through display is performed that determines a viewpoint at each of the plurality of points in accordance with a condition for the point, and displays a scenery corresponding to the determined viewpoint. This makes it possible for even a corner with a large change in visual field to have a continuous visual field and possible to display the state of the current route in an easy-to-understand manner for even a large change in visual field.

Note that the present disclosure is not limited to the above-described embodiment, and various modifications and applications are possible without departing from the spirit and scope of the present invention.

For example, an angle to be set as the first threshold value has been described as 22.5° byway of example, but the present invention is not limited to this, and the angle may be changed according to the actual view. For example, the first threshold value may be set according to the viewing angle and visual acuity of a pedestrian. Further, for example, depending on the state of the route on the map, if the route on the map is a wide field with few buildings, the first threshold value may be increased, and if the route on the map is a dense area of high-rise buildings and the like, the first threshold value may be changed so that the first threshold value is reduced. Further, for example, the threshold value may be changed according to the weather. In this case, the node acquisition unit 101 may be configured to further acquire the state of the route on the map, and a first threshold value changing unit (not illustrated) may be configured to change the first threshold value according to the state of the route on the map.

Note that various types of processors other than the CPU may execute the walk-through display program executed by the CPU reading software (program) in the above embodiment. Examples of such processors include a PLD (Programmable Logic Device) whose circuitry is reconfigurable after manufacturing, such as an FPGA (Field-Programmable Gate Array); and a dedicated electric circuit, which is a processor having circuitry exclusively designed to execute specific processing, such as an ASIC (Application Specific Integrated Circuit). Further, the walk-through display program may be executed on one of these various types of processors, or a combination of two or more processors of the same type or different types (e.g., a plurality of FPGAs, and a combination of a CPU and an FPGA, etc.). Further, the hardware structure of these various types of processors is, more specifically, an electric circuit in which circuit elements such as semiconductor elements are combined.

Further, in each of the above embodiments, an aspect has been described in which the walk-through display program is stored (installed) in the ROM 12 or the storage 14 in advance, but the present invention is not limited to this. The program may be provided in a form to be stored in a non-transitory storage medium such as a CD-ROM (Compact Disk Read Only Memory), a DVD-ROM (Digital Versatile Disk Read Only Memory), and a USB (Universal Serial Bus) memory. Further, the program may be downloaded from an external device via a network.

The following Notes will be further disclosed with respect to the above embodiments.

### (Note 1)

A walk-through display device including: a memory; and at least one processor connected to the memory, wherein the processor is configured to acquire a plurality of nodes included in a route on a map; group the plurality of nodes into groups having no change in line-of-sight in an order of travel direction on the route; generate, for each of the groups grouped by the route grouping unit, a plurality of points included in a route of the group so that the route is divided into smaller sections by the points from a start point of the group toward an end point of the group; determine, for each of the plurality of points generated by the point generation unit, a viewpoint in accordance with a condition of the point; and perform walk-through display for displaying a scenery during traveling on the route, the walk-through display displaying, at each of the plurality of points, a scenery corresponding to the viewpoint determined by the viewpoint determination unit.

### (Note 2)

A non-transitory storage medium that stores a walk-through display program causing a computer to execute: acquire a plurality of nodes included in a route on a map; group the plurality of nodes into groups having no change in line-of-sight in an order of travel direction on the route; generate, for each of the groups grouped by the route grouping unit, a plurality of points included in a route of the group so that the route is divided into smaller sections by the points from a start point of the group toward an end point of the group; determine, for each of the plurality of points generated by the point generation unit, a viewpoint in accordance with a condition of the point; and perform walk-through display for displaying a scenery during traveling on the route, the walk-through display displaying, at each of the plurality of points, a scenery corresponding to the viewpoint determined by the viewpoint determination unit.

### REFERENCE SIGNS LIST

10 Walk-through display device
11 CPU
12 ROM
13 RAM
14 Storage
15 Input unit
16 Display unit
17 Communication interface
19 Bus
101 Node acquisition unit
102 Route grouping unit
103 Point generation unit
104 Viewpoint determination unit
105 Walk-through display unit

1. A walk-through display device comprising:
a node acquirer configured to acquire a plurality of nodes included in a route on a map;
a route grouper configured to group the plurality of nodes into groups having no change in line-of-sight in an order of travel direction on the route;
a point generator configured to generate, for each of the groups grouped by the route grouper, a plurality of points included in a route of the group such that the route is divided into smaller sections by the points from a start point of the group toward an end point of the group;
a viewpoint determiner configured to determine, for each of the plurality of points generated by the point generator, a viewpoint in accordance with a condition of the point; and
a walk-through displayer configured to perform walk-through display for displaying a scenery during traveling on the route, the walk-through displayer displaying, at each of the plurality of points, a scenery corresponding to the viewpoint determined by the viewpoint determiner.

2. The walk-through display device according to claim 1, wherein the route grouper determines that there is a change in line-of-sight at a node of interest of the plurality of nodes when an angle by which a viewpoint turns to a direction of viewpoint from the node of interest to a node next to the node of interest with respect to a direction of viewpoint from a node immediately preceding the node of interest to the node of interest is larger than a predetermined first threshold value, and generates a group having the node of interest serving as an end point and a group having the node of interest serving as a start point.

3. The walk-through display device according to claim 1, wherein, for each of the groups grouped by the route grouper,
the viewpoint determiner sets, for each point of the group other than the point corresponding to the end point of the group, a point next to each point as a viewpoint, and
determines, for the point corresponding to the end point of the group, a viewpoint according to an angle by which the viewpoint turns to a direction of viewpoint from a point corresponding to an end point to a point next to the point corresponding to the end point with respect to a direction of viewpoint from a point immediately preceding the point corresponding to the end point to the point corresponding to the end point.

4. A walk-through display method comprising:
acquiring, by a node acquirer, a plurality of nodes included in a route on a map;
grouping, by a route grouper, the plurality of nodes into groups having no change in line-of-sight in an order of travel direction on the route;
generating, by a point generator, for each of the groups grouped by the route grouping unit, a plurality of points included in a route of the group such that the route is divided into smaller sections by the points from a start point of the group toward an end point of the group;
determining, by a viewpoint determiner, for each of the plurality of points generated by the point generator, a viewpoint in accordance with a condition of the point; and
performing, by a walk-through displayer, walk-through display for displaying a scenery during traveling on the route, the walk-through displayer displaying, at each of the plurality of points, a scenery corresponding to the viewpoint determined by the viewpoint determiner.

5. A computer-readable non-transitory recording medium storing computer-executable program instructions for walk-through display that when executed by a processor cause causing a computer system to execute:
acquire, by a node acquirer, a plurality of nodes included in a route on a map;
group, by a route grouper, the plurality of nodes into groups having no change in line-of-sight in an order of travel direction on the route;
generate, by a point generator, for each of the groups grouped by the route grouper, a plurality of points included in a route of the group such that the route is divided into smaller sections by the points from a start point of the group toward an end point of the group;
determine, by a viewpoint determiner, for each of the plurality of points generated by the point generator, a viewpoint in accordance with a condition of the point; and
performing, by a walk-through displayer, walk-through display for displaying a scenery during traveling on the route, the walk-through displayer displaying, at each of the plurality of points, a scenery corresponding to the viewpoint determined by the viewpoint determiner.

6. The walk-through display device according to claim 2, wherein, for each of the groups grouped by the route grouper,
the viewpoint determiner sets, for each point of the group other than the point corresponding to the end point of the group, a point next to each point as a viewpoint, and
determines, for the point corresponding to the end point of the group, a viewpoint according to an angle by which the viewpoint turns to a direction of viewpoint from a point corresponding to an end point to a point next to the point corresponding to the end point with respect to a direction of viewpoint from a point immediately preceding the point corresponding to the end point to the point corresponding to the end point.

7. The walk-through display method according to claim 4, wherein the route grouper determines that there is a change in line-of-sight at a node of interest of the plurality of nodes when an angle by which a viewpoint turns to a direction of viewpoint from the node of interest to a node next to the node of interest with respect to a direction of viewpoint from a node immediately preceding the node of interest to the node of interest is larger than a predetermined first threshold value, and generates a group having the node of interest serving as an end point and a group having the node of interest serving as a start point.

8. The computer-readable non-transitory recording medium according to claim 5, wherein the route grouper determines that there is a change in line-of-sight at a node of interest of the plurality of nodes when an angle by which a viewpoint turns to a direction of viewpoint from the node of interest to a node next to the node of interest with respect to a direction of viewpoint from a node immediately preceding the node of interest to the node of interest is larger than a predetermined first threshold value, and generates a group having the node of interest serving as an end point and a group having the node of interest serving as a start point.

9. The walk-through display method according to claim 7,
wherein the route grouper determines that there is a change in line-of-sight at a node of interest of the plurality of nodes when an angle by which a viewpoint turns to a direction of viewpoint from the node of interest to a node next to the node of interest with respect to a direction of viewpoint from a node immediately preceding the node of interest to the node of interest is larger than a predetermined first threshold value, and generates a group having the node of interest serving as an end point and a group having the node of interest serving as a start point.

10. The walk-through display method according to claim 7, wherein, for each of the groups grouped by the route grouper,
the viewpoint determiner sets, for each point of the group other than the point corresponding to the end point of the group, a point next to each point as a viewpoint, and
determines, for the point corresponding to the end point of the group, a viewpoint according to an angle by which the viewpoint turns to a direction of viewpoint from a point corresponding to an end point to a point next to the point corresponding to the end point with respect to a direction of viewpoint from a point immediately preceding the point corresponding to the end point to the point corresponding to the end point.

11. The computer-readable non-transitory recording medium according to claim 8,
wherein the route grouper determines that there is a change in line-of-sight at a node of interest of the plurality of nodes when an angle by which a viewpoint turns to a direction of viewpoint from the node of interest to a node next to the node of interest with respect to a direction of viewpoint from a node immediately preceding the node of interest to the node of interest is larger than a predetermined first threshold value, and generates a group having the node of interest serving as an end point and a group having the node of interest serving as a start point.

12. The computer-readable non-transitory recording medium according to claim 8, wherein, for each of the groups grouped by the route grouper,
the viewpoint determiner sets, for each point of the group other than the point corresponding to the end point of the group, a point next to each point as a viewpoint, and
determines, for the point corresponding to the end point of the group, a viewpoint according to an angle by which the viewpoint turns to a direction of viewpoint from a point corresponding to an end point to a point next to the point corresponding to the end point with respect to a direction of viewpoint from a point immediately preceding the point corresponding to the end point to the point corresponding to the end point.
